(19) United States
(12) Patent Application Publication
(10) Pub. No.: US 2012/0301657 A1
(43) Pub. Date: Nov. 29, 2012

(54) PHOTOLUMINESCENT DECAL DEVICE FOR FORMING A MARKER

(75) Inventor: Stein Dietrichsson, Fredrikstad (NO)

(73) Assignee: RE-TURN AS, Gamle Fredrikstad (NO)

(21) Appl. No.: 13/520,507

(22) PCT Filed: Feb. 3, 2011
(86) PCT No.: PCT/NO2011/000045

§ 371 Date: Aug. 14, 2012

(30) Foreign Application Priority Data
Feb. 4, 2010 (NO) 20100187

(51) Int. Cl. B32B 3/02; B05D 5/06; B32B 37/12

(52) U.S. Cl. 428/80; 156/67; 427/157

(57) ABSTRACT

A photoluminescent decal device for light marking arranged for being placed by or onto a transport path, wherein said photoluminescent decal device comprises the following features:—a lower non stick liner (5) arranged to cover an above arranged adhesive layer (4) arranged for the attachment of said decal device to a substrate,—a ply of a reflective layer (3) arranged above said adhesive layer (4), said reflective layer comprising reflective material arranged to reflect incoming light from overlying successive layers,—one or more photoluminescent layers (2) arranged above said reflective layer (3), where said photoluminescent layer (2) comprises strontium aluminate dispersed in a transparent binder and arranged for receiving light and delayedly emitting light,—a base foil (1) in the form of a transparent polymer arranged on said one or more photoluminescent layer (2),—a layer of a relatively thick transparent layer (6) of polyurethane or similar material, arranged on said basefoil (1), arranged for protecting said photo luminescent layer.

The present invention relates to a slightly elevated, but rather low, marking decal device for marking of roads, emergency exits, steps in stairs, escape routes, aisles in planes/trains/bus, tunnel, and the like, where it is important that the decal device is after glowing or so-called photo luminescent. The device, according to the invention will be charged by sunlight when exposed to daylight, or by ordinary artificial illuminating sources like lamps in buildings and tunnels, or the headlights of vehicles in motion along the road path. The marking device according to the invention will form raised markers on the road surface and due to the fact that the top abrasion resistant layer has a certain thickness and is transparent it will emit visible light both vertically and sideways so as for easily being seen. Experiments have proven that the top layer is slowly worn down and remains transparent.

### SHORT SUMMARY OF THE INVENTION

The invention is a photo luminescent decal device for light marking arranged for being placed by onto a road path, wherein the photo luminescent decal device comprises the following features:
a lower non stick liner (5) arranged to cover an above arranged adhesive layer (4) arranged for the attachment of the decal device to a substrate where the cover foil is arranged to be removed before the mounting on the substrate,
a layer of a reflective material (3) applied above the adhesive layer (4), wherein the reflective layer mainly comprises an essentially white reflective material arranged to reflect incoming light from the overlying subsequent layers,
one or more photo luminescent layers (2) arranged above the reflective layer (3), where the photo luminescent layer (2) comprises Strontium Aluminate dispersed in a transparent binder and arranged for receiving light and delayedly emitting light,
a base foil (1) in the form of a transparent polymer arranged on the one or more photoluminescent layer (s) (2),
a layer of a relatively thick transparent layer (6) of polyurethane or similar material, arranged on the base foil (1), arranged for protecting the photo luminescent layer.

The invention is also a method to manufacture a photo luminescent decal device (0) including the following steps:
providing a base film (1) of a transparent polymer,
application of one or more layers of photo luminescent (2) Strontium Aluminate dispersed in a binder (22), onto the transparent base film (1),
application of a layer of a reflective material (3) of white reflective material onto the photo luminescent layer (2),
application of an adhesive film (4) onto the reflective layer (3) and a suitable non stick liner (5) onto adhesive layer (4),
application of a relatively thick transparent abrasion resistant layer (6) on the reverse face of the base film (1) relative to the photo luminescent layer (2), where the transparent abrasion resistant layer (6) is formed from a durable, elastic polyurethane or similar material.

In an alternate embodiment of the invention it is a method for manufacturing a photo luminescent decal device (0), by inline extrusion of
a relatively thick transparent abrasion resistant layer (6) of durable, elastic polyurethane or the like,
a photo luminescent layer (2) of Strontium Aluminate dispersed in a binder (22),
a layer of a reflective material (3) onto the photo luminescent layer (2),
wherein an adhesive layer (4) is applied onto the reflective layer (3).

### SHORT FIGURE CAPTION

FIG. 1 is a cross-section embodiment of a photo luminescent decal device according to the invention. The figure showing the layer structure of a substrate (10), for example asphalt, a step in stairs, a floor; an adhesive layer on the floor; a reflective layer onto the adhesive layer; one or more photo luminescent layer on the reflective layer; a transparent so-called “base film” on the top of photo luminescent layers; where the base film serves an purpose in the manufacturing process itself and for holding the subsequent decal shaped thick polyurethane abrasion resistant layer on top. FIG. 1 shows the photo luminescent decal device arranged on a road surface (10). The figure shows imagined light beams for incoming light, reflected light and after glow light.

FIG. 2 shows the structure of the process layer by layer from the first step in the manufacturing process which may be called the base layer, then a photo luminescent layer, a reflective layer, and then an adhesive layer and a non sticking liner. Subsequently the entire lay-up is turned around in order to apply the abrasion resistant layer on the opposite side of the base film.

FIG. 3 shows the turned lay-up structure arranged to receive the transparent abrasion resistant layer to be applied onto the base film.

FIG. 4 shows the final step in the layup of the decal device or marking device according to the invention where the transparent abrasion resistant layer is arranged.

FIGS. 5 and 6 show images of the decal formed marking device in artificial light and placed on a dark substrate in dimmed light where the device is clearly glowing after having been illuminated with a strong light beam.

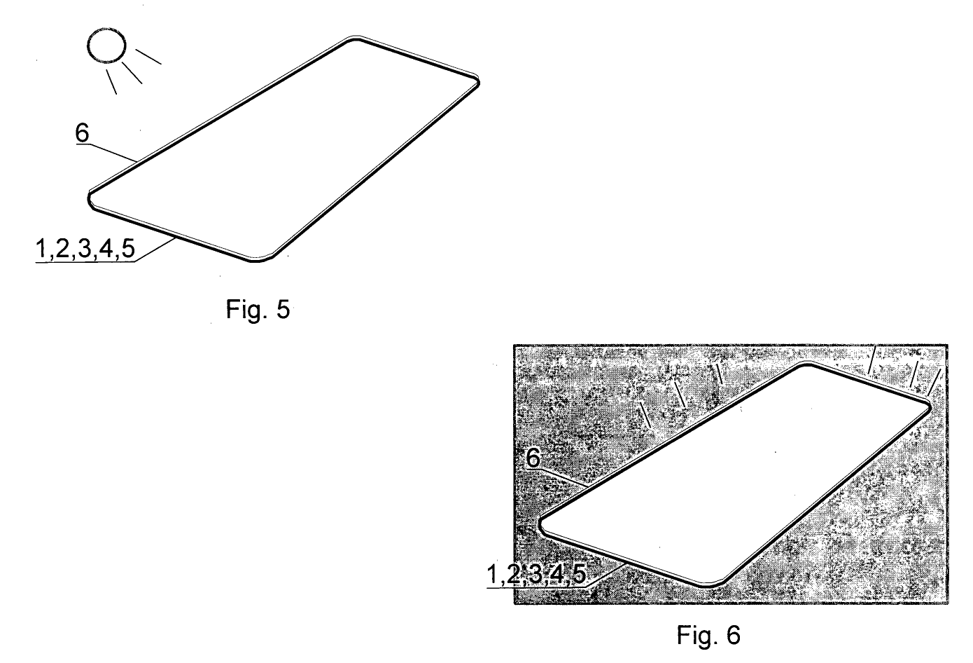

### DESCRIPTION OF EMBODIMENT OF THE INVENTION

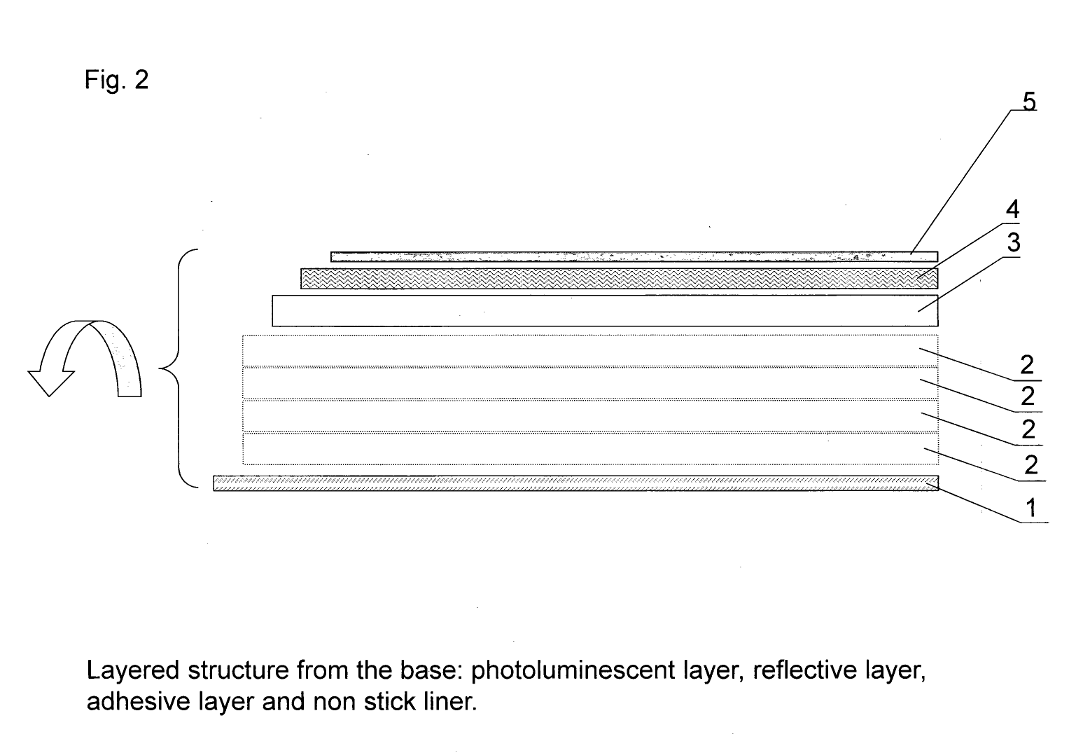

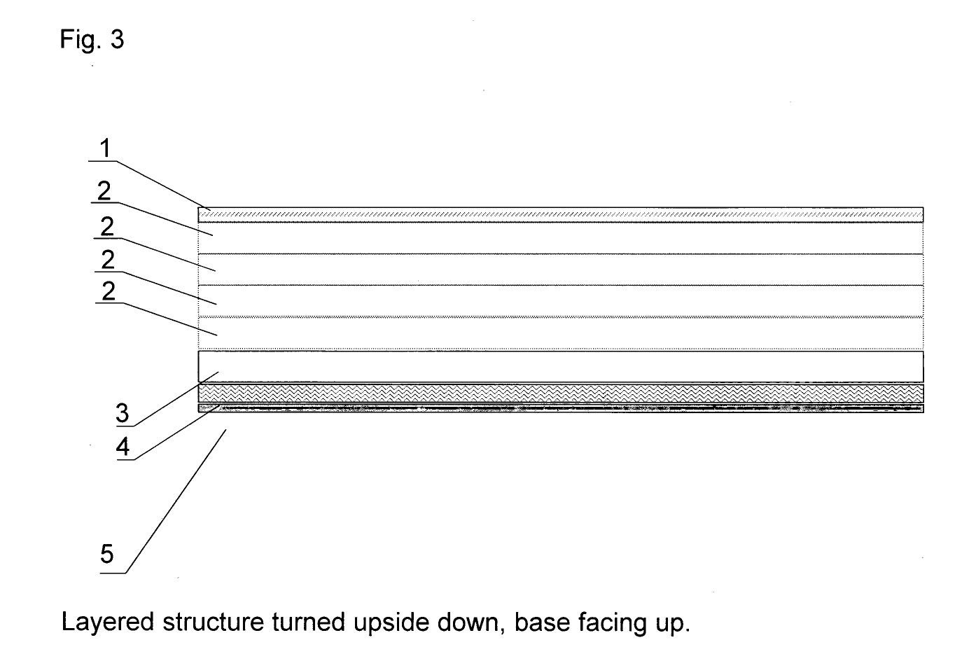

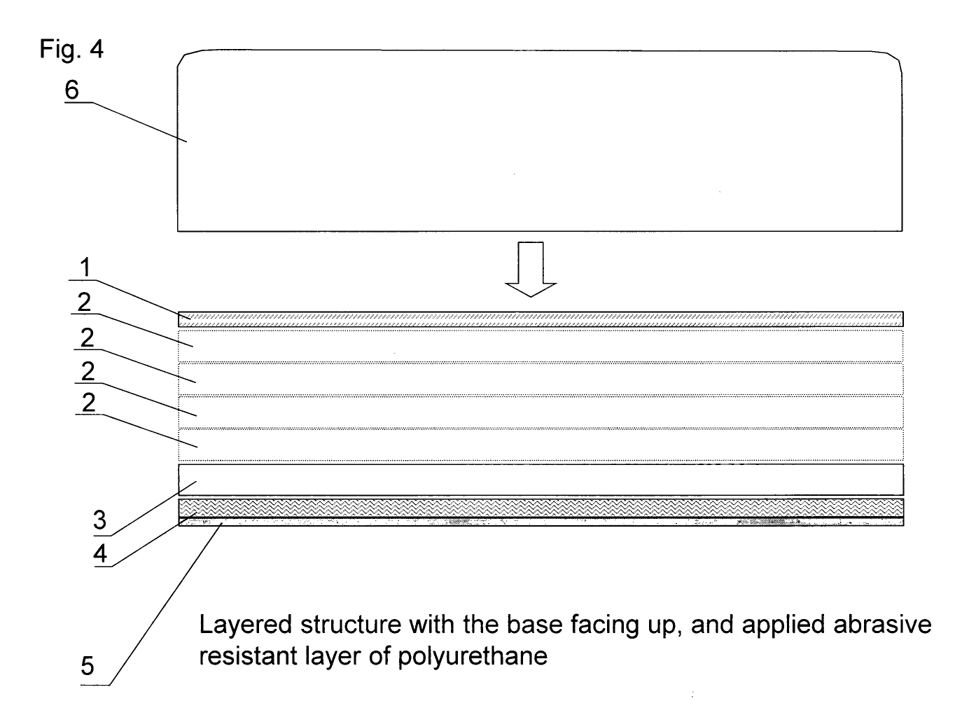

The invention relates to a method for manufacturing a photo luminescent or so-called “fluorescent” marking device, also called a decal device (0) comprising the following steps:
First a base film (1) of a transparent polymer is provided.
Then one or more layers of photo luminescent (2) Strontium Aluminate dispersed in a binder (22) is applied onto the transparent film (1). This may be done by a printing operation process or by painting.
Then a layer of reflective layer (3) of white reflective material is applied onto the photo luminescent layer (2). Also this may be done by printing or painting.
An adhesive layer (4) is applied to the reflective layer (3) and a suitable non stick liner (5) is arranged on the adhesive layer (4). This layered structure is shown in FIG. 2.
Subsequently preferably the entire lay-up is turned around so as for the base film to face forward, see FIG. 3. Then a relatively thick transparent abrasion resistant layer (6) is applied onto the base film (1) on the reverse face relative to the photo luminescent layer (2), see FIG. 4. The application may be done by gluing. The transparent abrasion resistant layer (6) is in a preferred embodiment of the invention formed from a durable, elastic polyurethane or similar material.

One may also manufacture the entire lay-up in an embodiment of the method according to the invention in the reverse order: Using the transparent abrasion resistant layer (6) as a base for any transparent polymer film (1) (which may be excluded with formation in this sequence), applying the photo luminescent layer (2) with its transparent matrix, then the reflective layer (3), the adhesive layer (4), and then the non stick liner (5).

The entire lay-up may also be extruded such as a long extended decal. Such a decal may be manufactured having rounded edges on the transparent abrasion resistant layer, the polyuretan layer (6), and is suitable for being placed onto the floor or along the wall or along emergency exits for example along aisles in airplane. Such an extrusion process may also be used as a continuous process for road marking where the road is applied with a continuous stripe mainly immediately after the extrusion of the decal.

In a preferred embodiment of the invention the abrasion resistant layer (6) is applied to cover at least a somewhat larger area than the area of the reflecting layer (3) and the photo luminescent layer (2).

The resulting after-glowing, preferably photo luminescent marking or decal device (0) for light marking is arranged to be placed by or onto a road or other substrates (10), wherein the photo luminescent decal device comprises the following features:
a lower non stick liner (5) arranged to cover a above arranged adhesive layer (4) arranged for the attachment of the decal device to a substrate, wherein the non stick liner is arranged to be removed before being placed on a substrate,
a layer of a reflecting material (3) arranged above the adhesive layer (4), wherein the reflecting layer (3) comprises mainly a white reflecting material arranged to reflect incoming light from overlying successive layers,
one or more photo luminescent layers (2) arranged above the reflective layer (3), wherein the photo luminescent layer (2) comprises Strontium Aluminate dispersed in a transparent binder and arranged for receiving light and delayedly emitting light,
a so-called base film (1) in the form of a transparent polymer arranged on one or more photo luminescent layer (2),
a layer of a relatively thick transparent layer (6) of polyurethane arranged on the base film (1), arranged for protecting the photo luminescent layer.

In a preferred embodiment of the invention the transparent abrasion resistant layer (6) of polyurethane preferably have rounded or chamfered edges.

The non stick liner may be a waxed paper or a silicone-coated film preventing permanent adhesion to the adhesive layer which is removed prior to assembling the marking on the substrate. The adhesive layer (4) must be sufficiently soft and thick, or the entire device so flexible, that the adhesive layer achieves adequate contact with the substrate. This is particularly important for attaching onto asphalt and concrete which tend to have a quite rough and uneven, partially also having a porous surface.

In the method of the invention the lay-up from the base film (1) to the non stick liner (5) may be manufactured in a printing and assembling operation while the subsequently formed layer of the relatively thick transparent abrasion resistant layer (6) may be applied to the base layer (1) as a pre-cast, separately manufactured, preferably moulded transparent component, if it is too thick to be produced during the printing process. The transparent abrasion resistant layer (6) may alternatively be applied directly in the printing process.

### ADVANTAGES OF THE INVENTION

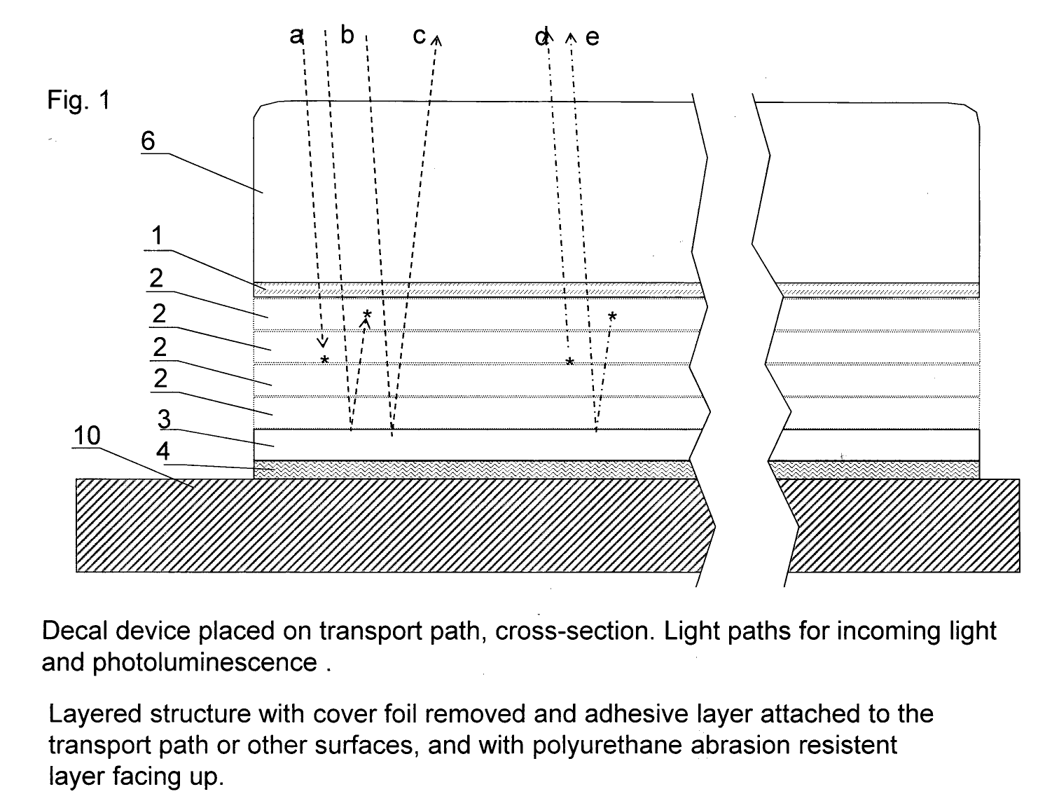

An advantage of the material lay-up of the marking device with its transparent and reflective layers is as follows: the light passing through the photo luminescent layer (2) without being absorbed, please see the light beam marked (a) in FIG. 1, will be reflected back from the reflective layer (3) to the photo luminescent layer (2). The Strontium Aluminate is charged either by being directly illuminated or indirectly by reflected light.

The photo luminescent decal device (0) is made visible immediately when illuminated: parts of the light not being absorbed by the Strontium Aluminate will be reflected back by the reflective layer (3), because the above arranged layers (2), (1) and (6) are transparent, please see FIG. 1, ray (c).

a) incoming light beams are absorbed and will charge the Strontium Aluminate, see FIG. 1, beam (a).

b) incoming light reflected from the reflecting layers (3) will be absorbed and charges the Strontium Aluminate layer (2) see FIG. 1, beam (b).

C) part of the incoming light will be reflected directly from the reflecting layer (3) without recharging Strontium Aluminate, in this way the decal device functions as an ordinary reflective road marking, see FIG. 1, beam (c).

d) charged Strontium Aluminate emits light directly out, please see FIG. 1, beam (d).

e) light from Strontium Aluminate is emitted towards the reflective layer (3). The reflective layer (3) reflects the light out through the layer with Strontium Aluminate and further out through the polyurethane layer (6), please see FIG. 1, beam (e).

Semi transparent symbols may be printed or painted directly onto the basic film (1), onto the photo luminescent layer (2), or onto the reflecting layer (3), and will thus be protected and form a darker pattern in the fluorescent decal device in the dark and simultaneously be visible both in daylight or in artificial light.

1-12. (canceled)

13. A method of manufacturing a photoluminescent decal device comprising the following steps:
providing a base film of a transparent polymer,
application of one or more layers of photoluminescent strontium aluminate dispersed in a binder onto said transparent base film,
application of a layer of a reflective material onto said photo luminescent layer,
application of an adhesive layer onto said reflective layer and a suitable non stick liner onto said adhesive layer, wherein
turning around said entire lay-up with said base film facing forward after the step of application of said adhesive layer and said non stick liner, and subsequently said relatively thick transparent abrasion resistant layer is applied onto said base film,
application of a relatively thick transparent abrasion resistant layer on the reverse face of said base film relative to said photo luminescent layer, wherein said transparent abrasion resistant layer is formed from a durable, elastic polyurethane or the like.

14. The method according to claim 13, wherein said abrasion resistant layer is applied over at least a slightly larger area than an area of said reflecting layer and said photoluminescent layer.

15. The method according to claim 13, wherein during said application of said reflective layer is used a generally white material.

16. A photoluminescent decal device for light marking arranged for being placed by or onto a transport path, wherein said photoluminescent decal device comprises the following features:
a lower non stick liner arranged to cover an above arranged adhesive layer arranged for the attachment of said decal device to a substrate,
a ply of a reflective layer arranged above said adhesive layer, said reflective layer comprising reflective material arranged to reflect incoming light from overlying successive layers,
one or more photoluminescent layers arranged above said reflective layer, where said photoluminescent layer comprises strontium aluminate dispersed in a transparent binder and arranged for receiving light and delayedly emitting light,
a base foil in the form of a transparent polymer arranged on said one or more photoluminescent layer,
a layer of a relatively thick transparent layer of polyurethane or similar material, arranged on said basefoil, arranged for protecting said photo luminescent layer, characterised by that
said transparent abrasive-resistant layer having mainly rounded or chamfered edges.

17. The decal device according to claim 16, said reflecting material being substantially white.

18. The decal device according to claim 16, said path being a road, emergency exits, steps in stairs, fire escape, aisles in airplane or train or bus, or a tunnel, etc.

19. A method of manufacturing a photoluminescent decal device comprising the following steps:
providing a relatively thick transparent abrasion resistant layer, said transparent abrasion resistant layer formed in durable elastic polyurethane or the like,
application of one or more photoluminescent layers of strontium aluminate dispersed in a binder on one face of said durable layer,
application of a layer of a reflective material on said photoluminescent layer,
application of an adhesive layer on said reflective layer and a suitable non stick liner on said adhesive layer.

20. The method according to claim 19, wherein a transparent base film of transparent polymer is arranged on one face of said abrasion resistant layer before said photoluminescent is applied.

21. A method of manufacturing a photoluminescent decal device by simultaneous extrusion of
a relatively thick transparent abrasion resistant layer of durable, elastic polyurethane or the like,
a photo luminescent layer of strontium aluminate dispersed in a binder,
a layer of a reflective material on said photo luminescent layer, and
wherein is applied an adhesive layer on said reflective layer.

22. The method according to claim 21, wherein a suitable non stick liner is applied onto adhesive layer.
